(19) United States
(12) Patent Application Publication
(10) Pub. No.: US 2026/0254227 A1
(43) Pub. Date: Aug. 27, 2026

(54) LOW-POWER UNDERVOLTAGE LOCKOUT CIRCUITS

(71) Applicant: Qorvo US, Inc., Greensboro, NC (US)

(72) Inventors: Daijiro Otani, Plano, TX (US); Huang Yao, Richardson, TX (US)

(21) Appl. No.: 19/544,180

(22) Filed: Feb. 19, 2026

Related U.S. Application Data
(60) Provisional application No. 63/763,662, filed on Feb. 26, 2025.

(51) Int. Cl. H02H 3/24; H02H 1/00; H02H 3/06

(52) U.S. Cl. CPC H02H 3/24; H02H 1/0007; H02H 3/066

(57) ABSTRACT

An undervoltage lockout (UVLO) circuit is provided. The UVLO circuit includes a first branch with a first transistor and a feedback transistor, and a second branch with a second transistor. Herein, source electrodes of the first transistor and the second transistor are electrically coupled to an input voltage, a gate electrode and a drain electrode of the first transistor and a gate electrode of the second transistor are electrically coupled to a source electrode of the feedback transistor, and a drain electrode of the second transistor is electrically coupled to a gate electrode of the feedback transistor. In response to the input voltage being below a threshold value, the feedback transistor is turned off. In response to the input voltage being above the threshold value, the feedback transistor is turned on and a voltage at the gate electrode of the feedback transistor becomes a constant voltage value.

### RELATED APPLICATIONS

This application claims the benefit of provisional patent application Ser. No. 63/763,662, filed Feb. 26, 2025, the disclosure of which is hereby incorporated herein by reference in its entirety.

### FIELD OF THE DISCLOSURE

The present disclosure relates to electronic systems, and undervoltage lockout (UVLO) circuits, in particular, low-power UVLO circuits.

### BACKGROUND

An undervoltage lockout (UVLO) circuit is a critical safety feature in modern electronic systems designed to prevent damage to components and ensure reliable operation when the supply voltage falls below a predefined threshold. UVLO circuits monitor the input voltage and disable the system or load when the voltage is too low, thereby protecting devices from improper functioning or potential damage caused by insufficient power levels.

However, existing UVLO circuits can consume undesirably high power, increasing the operational cost. Thus, a low-power UVLO circuit is desired.

### SUMMARY

Embodiments of the present disclosure provide an undervoltage lockout (UVLO) circuit. The UVLO circuit includes a first branch with a first transistor and a feedback transistor, and a second branch with a second transistor. Herein, a source electrode of the first transistor is electrically coupled to an input voltage, and a drain electrode and a gate electrode of the first transistor are electrically coupled to a source electrode of the feedback transistor. A source electrode of the second transistor is electrically coupled to the input voltage, a drain electrode of the second transistor is electrically coupled to a gate electrode of the feedback transistor, and a gate electrode of the second transistor is electrically coupled to the gate electrode of the first transistor. In response to the input voltage being below a threshold value, the feedback transistor is turned off. In response to the input voltage being above the threshold value, the feedback transistor is turned on and a voltage at the gate electrode of the feedback transistor becomes a constant voltage value.

In some embodiments, in response to the input voltage being above the threshold value, the voltage at the gate electrode of the feedback transistor is equal to the input voltage subtracted by a gate-source voltage of the first transistor and a gate-source voltage of the feedback transistor. A current in the first branch is equal to a source-drain current of the feedback transistor.

In some embodiments, the first transistor, the feedback transistor, and the second transistor are each a p-channel metal-oxide-semiconductor field-effect transistor (PMOS).

In some embodiments, a threshold voltage of the feedback transistor is between about 0 V and about (−0.25) V, and a threshold voltage of the first transistor is between about (−0.7) V and about (−0.9) V.

In some embodiments, a ratio between a width of the first transistor and a width of the second transistor is about 2:1.

In some embodiments, the first branch further includes a third transistor having a drain electrode electrically coupled to the drain electrode of the feedback transistor at a first node, a source electrode electrically coupled to ground (GND), and a gate electrode electrically coupled to the drain electrode of the feedback transistor at a second node. The second node is positioned closer to the drain electrode of the feedback transistor than the first node. The first branch further includes a first resistor electrically coupled between the first node and the second node.

In some embodiments, the second branch further includes a fourth transistor having a drain electrode electrically connected to the drain electrode of the second transistor, a source electrode electrically coupled to GND, and a gate electrode electrically coupled to the first node. A ratio between a width of the third transistor and a width of the fourth transistor is about 1:4.

In some embodiments, the third transistor and the fourth transistor are each an n-channel metal-oxide-semiconductor field-effect transistor (NMOSFET).

In some embodiments, the UVLO circuit further includes a third branch comprising a second resistor, a fifth transistor, and a sixth transistor. The second resistor is electrically coupled between the input voltage and the fifth transistor. The fifth transistor has a drain electrode electrically coupled to the second resistor, a source electrode electrically coupled to a drain electrode of the sixth transistor, and a gate electrode electrically coupled to the first branch. The sixth transistor has a source electrode electrically connected to GND, and a gate electrode electrically connected to the gate electrode of the feedback transistor.

In some embodiments, a resistance of the second resistor is between about 75 MΩ and about 155 MΩ.

In some embodiments, the UVLO circuit further includes a start-up circuit electrically coupled to the second branch and the third branch. The start-up circuit is configured to set the voltage at the gate electrode of the feedback transistor to a nonzero value when the input voltage is below the threshold value. The start-up circuit is also configured to set the voltage at the gate electrode of the feedback transistor to the input voltage subtracted by the gate-source voltage of the first transistor and the gate-source voltage of the feedback transistor when the input voltage is equal to or greater than the threshold value.

In some embodiments, the start-up circuit includes a seventh transistor having a drain electrode and a gate electrode each electrically connected to the drain electrode of the second transistor, and a source electrode electrically connected to a drain electrode of an eighth transistor. The start-up circuit may also include the eighth transistor having a gate electrode electrically connected to the drain electrode of the fifth transistor, and a source electrode electrically connected to GND. The nonzero value is equal to a sum of a gate-to-source voltage of the seventh transistor and a drain-to-source voltage of the eighth transistor.

In some embodiments, a width-to-length ratio of the seventh transistor is about 0.42 μm/1 μm, and a width-to-length ratio of the eighth transistor is about 1 μm/1 μm.

In some embodiments, a threshold voltage of the seventh transistor is the same as a threshold voltage of the sixth transistor.

In some embodiments, a length of the seventh transistor is the same as a length of the sixth transistor. A width-to-length ratio of the sixth transistor is greater than a width-to-length ratio of the seventh transistor.

In some embodiments, the UVLO circuit further includes an output terminal electrically connected to the drain electrode of the fifth transistor via a number of inverters.

In some embodiments, the UVLO circuit further includes a first capacitor electrically connected to the input voltage and the drain electrode of the fifth transistor.

In some embodiments, the UVLO circuit further includes a second capacitor electrically connected to the gate electrode of the feedback transistor and GND, and a third capacitor electrically connected to the gate electrode of the feedback transistor and the output terminal.

In some embodiments, the first branch further comprises a hysteresis transistor, a third resistor, and a fourth resistor. Herein, the hysteresis transistor includes a source electrode electrically coupled to the drain electrode of the feedback transistor, a drain electrode electrically coupled to the second node via the third resistor, and a gate electrode electrically coupled to the output terminal via certain ones of the plurality of inverters. A voltage level at the gate electrode of the hysteresis is inverted from a voltage level at the output terminal. The fourth resistor is electrically coupled between the source electrode and the drain electrode of the hysteresis transistor.

According to some embodiments, a communication device includes receive circuitry, transmit circuitry, and antenna switching circuitry, which is configured to transmit radio frequency (RF) signals between antennas and the receive circuitry and/or between the antennas and the transmit circuitry. Herein, at least one UVLO circuit, which is configured to monitor an input voltage and disable circuitry when the voltage is too low, is included in at least one of the transmit circuitry, the receive circuitry, and the antenna switching circuitry. The UVLO circuit comprises a first branch and a second branch. The first branch comprises a first transistor and a feedback transistor, wherein a source electrode of the first transistor is electrically coupled to an input voltage, and a drain electrode and a gate electrode of the first transistor are electrically coupled to a source electrode of the feedback transistor. The second branch comprises a second transistor, wherein a source electrode of the second transistor is electrically coupled to the input voltage, a drain electrode of the second transistor is electrically coupled to a gate electrode of the feedback transistor, and a gate electrode of the second transistor is electrically coupled to the gate electrode of the first transistor. In response to the input voltage being below a threshold value, the feedback transistor is turned off, and in response to the input voltage being above the threshold value, the feedback transistor is turned on and a voltage at the gate electrode of the feedback transistor becomes a constant voltage value.

In another aspect, any of the foregoing aspects individually or together, and/or various separate aspects and features as described herein, may be combined for additional advantage. Any of the various features and elements as disclosed herein may be combined with one or more other disclosed features and elements unless indicated to the contrary herein.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure and, together with the description, serve to explain the principles of the disclosure.

FIG. 1A illustrates an existing undervoltage lockout (UVLO) circuit.

FIG. 1B shows a simplified circuit diagram of a core circuit of the UVLO circuit in FIG. 1A.

FIG. 2A illustrates an exemplary low-power UVLO circuit, according to some aspects of the present disclosure.

FIG. 2B shows a simplified circuit diagram of a core circuit of the low-power UVLO circuit in FIG. 2A, according to some aspects of the present disclosure.

FIG. 3 is a block diagram of a communication device, which may include at least one low-power UVLO circuit according to some embodiments of the present disclosure.

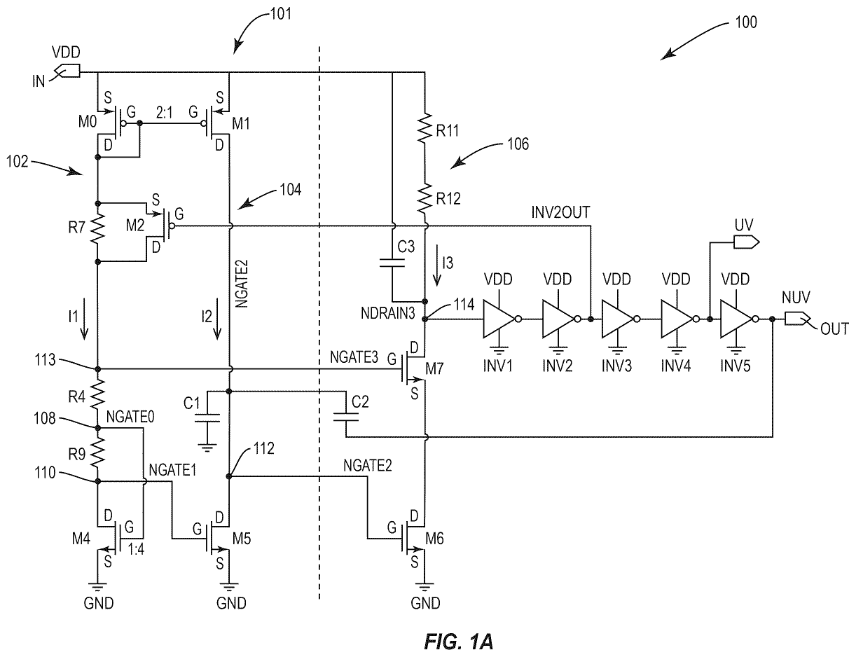

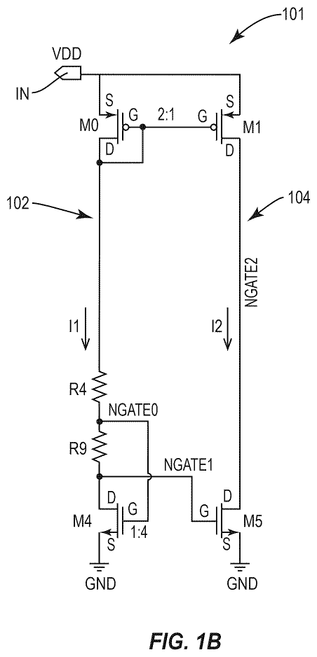

It will be understood that for clarity of illustration, FIGS. 1A-3 may not be drawn to scale.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Embodiments are described herein with reference to schematic illustrations of embodiments of the disclosure. As such, the actual dimensions of the layers and elements can be different, and variations from the shapes of the illustrations as a result, for example, of manufacturing techniques and/or tolerances, are expected. For example, a region illustrated or described as square or rectangular can have rounded or curved features, and regions shown as straight lines may have some irregularity. Thus, the regions illustrated in the figures are schematic and their shapes are not intended to illustrate the precise shape of a region of a device and are not intended to limit the scope of the disclosure. Additionally, sizes of structures or regions may be exaggerated relative to other structures or regions for illustrative purposes and, thus, are provided to illustrate the general structures of the present subject matter and may or may not be drawn to scale. Common elements between figures may be shown herein with common element numbers and may not be subsequently re-described.

As used herein, a p-channel metal-oxide-semiconductor field-effect transistor (P-MOSFET) can be used interchangeably with PMOS; and an n-channel metal-oxide-semiconductor field-effect transistor (N-MOSFET) can be used interchangeably with NMOS.

As used herein, “electrically coupled to” may refer to two or more electrical components that are connected in a way that allows electrical signals, current, or voltages to be transferred between them. The coupling can be direct (through a physical conductive path) or indirect (through electric or magnetic fields). As used herein, “electrically coupled to” can be used interchangeably with “electrically connected to.”

As used herein, a threshold voltage V_{TH} of a transistor may refer to a minimum gate-to-source voltage (V_{GS}) required to create a conducting channel between a drain electrode and a source electrode of the transistor. As used herein, V_{GS} may refer to an absolute value of the gate-to-source voltage of a transistor. For example, |V_{GS}_Mx| may represent the absolute value of the gate-to-source voltage of a transistor Mx. As used herein, V_{DS} may refer to a drain-to-source voltage of a transistor.

As used herein, a “branch” may refer to a current flow path. Nodes/electrodes/connections whose voltages are determined by the current flow may belong to the branch.

In practice, an undervoltage lockout (UVLO) circuit can be used in an electronic system to indicate if the supply voltage (VDD, or input voltage) has risen to a sufficiently high level, and shut down the system if the supply voltage has dropped lower than a safe operating threshold. For example, the electronic system operates at a stable state if the supply voltage is above a rising threshold, and shuts down if the supply voltage falls below a falling threshold. Often, the rising threshold is higher than the falling threshold, and a hysteresis value exists between the rising threshold and the falling threshold. The UVLO circuit, as part of or electrically coupled to the electronic system, can output a digital signal that indicates the level of the supply voltage. For example, a logic high at the output of the UVLO circuit can indicate the supply voltage is above the rising threshold, and a logic low at the output of the UVLO circuit can indicate the supply voltage is below the falling threshold. The output of the UVLO circuit can function as a control signal to control the electronic system, or can indicate the state of the voltage supply for the electronic system.

Because the UVLO constantly remains on to indicate the state of the supply voltage, it is important that the UVLO circuit consumes desirably low power such that the UVLO circuit does not consume a large portion of the power budget of the electronic system. One metric to measure the power consumption of a UVLO circuit is its quiescent current, which is the amount of current drawn by the UVLO circuit during a steady-state operation. An existing UVLO circuit can use an undesirably high portion of the power budget of an electronic system, potentially increasing the operational cost. A low-power UVLO circuit is thus desired.

Embodiments of the present disclosure provide low-power UVLO circuits with improved robustness. A low-power UVLO circuit of the present disclosure may include a feedback circuit configured to balance the current in the low-power UVLO circuit. The feedback circuit can reduce the quiescent current in the core circuit of the low-power UVLO circuit. The feedback circuit may be implemented by adding one or more transistors to form a feedback loop that limits the current in the two branches of the low-power UVLO circuit. Compared with increasing the number of resistors to reduce the quiescent current, the use of transistors requires significantly less chip area. To ensure proper system start-up, in some embodiments, the low-power UVLO circuit may further include a start-up circuit, which also includes one or more transistors. The start-up circuit ensures proper operation of the low-power UVLO circuit as the supply voltage ramps up. Accordingly, the low-power UVLO circuit effectively reduces power consumption while ensuring reliable start up without sacrificing chip area.

FIG. 1A shows a topology of an existing UVLO circuit 100, and FIG. 1B shows a simplified version of a core circuit 101 of the UVLO circuit 100. The quiescent current of the UVLO circuit 100 can be undesirably high. The UVLO circuit 100 includes an input terminal IN that is electrically coupled to a supply voltage VDD (e.g., a supply voltage of an electronic system and also an input voltage of the UVLO circuit 100), and an output terminal OUT configured to output a digital voltage (e.g., logic high or logic low) as active-low undervoltage or NUV. As mentioned above, a logic high NUV indicates the supply voltage VDD is above a safe operating threshold (e.g. above a rising threshold), and a logic low NUV indicates the supply voltage VDD is below the safe operating threshold (e.g., below a rising threshold or a falling threshold).

As shown in FIGS. 1A and 1B, the core circuit 101 shows a first branch 102 and a second branch 104 of the UVLO circuit 100. In some embodiments, the first branch 102 and the second branch 104 form a comparator circuit. In operation, the first branch 102 and the second branch 104 form an open loop current comparator. The first branch 102 includes a PMOS M0, a PMOS M2, an NMOS M4, and resistors R4, R7, R9. The PMOS M0 includes a source electrode electrically coupled to the supply voltage VDD, a drain electrode electrically coupled to a first terminal of the resistor R7 and a source electrode of the PMOS M2, and a gate electrode electrically coupled to the first branch 102 (i.e. the drain electrode and the gate electrode of the PMOS M0 are electrically connected). Besides the source electrode, the PMOS M2 also includes a drain electrode electrically coupled to a second terminal of the resistor R7 and a first terminal of the resistor R4, and a gate electrode electrically connected to a logic signal INV2OUT, which is inverted from NUV. The PMOS M2 creates a hysteresis value between the rising threshold and the falling threshold. The resistor R7 is electrically coupled between the source electrode and the drain electrode of the PMOS M2. The resistor R4 is electrically connected to the resistor R9 in series. The NMOS M4 includes a drain electrode electrically connected to the resistor R9 in the first branch 102, a source electrode electrically connected to ground (GND), and a gate electrode electrically coupled to a joint node 108 (with a voltage of NGATE0) between the resistors R4 and R9.

The second branch 104 includes a PMOS M1 and an NMOS M5. The second branch 104 can also be regarded as a comparator branch. The PMOS M1 includes a source electrode electrically coupled to the supply voltage VDD, a drain electrode electrically coupled to a drain electrode of the NMOS M5, and a gate electrode electrically coupled to the gate electrode of the PMOS M0. The width ratio between the PMOSs M0 and M1 may be about 2:1. Besides the drain electrode, the NMOS M5 also includes a source electrode electrically connected to GND, and a gate electrode electrically coupled to a joint node 110 between the resistor R9 and the NMOS M4 (e.g., the drain electrode of the NMOS M4, with a voltage of NGATE1). Additionally, a first capacitor C1 might be electrically coupled between a joint node 112 of the PMOS M1 and the NMOS M5 (e.g., the drain electrodes of M5 and M1) and GND, while a second capacitor C2 might be electrically coupled between the joint node 112 and the output terminal OUT of the UVLO circuit 100. The voltage at the drain electrode of the PMOS M1 or the drain voltage of the NMOS M5 is referred to as NGATE2. A width ratio between the NMOSs M4 and M5 is about 1:4.

The UVLO circuit 100 further includes a third branch 106, which can also be referred to as an output branch. The third branch 106 may include resistors R11 and R12, an NMOS M6, and an NMOS M7. The resistor R11 is electrically connected to the supply voltage VDD and is electrically connected to the resistor R12 in series. A drain electrode of the NMOS M7 is electrically connected to the resistor R12, and a source electrode of the NMOS M7 is electrically connected to a drain electrode of the NMOS M6. A gate electrode of the NMOS M7 is electrically connected to a joint node 113 between the resistors R7 and R4 (or the drain electrode of the PMOS M2). Besides the drain electrode, the NMOS M6 also includes a source electrode electrically coupled to GND, and a gate electrode electrically connected to the joint node 112 (or the drain electrodes of the NMOS M5 and the PMOS M1). The third branch 106 further includes a third capacitor C3 electrically connected between the supply voltage VDD and a joint node 114 between the resistor R12 and the NMOS M7 (e.g., the drain electrode of the NMOS M7, with a voltage of an NDRAIN3). The UVLO circuit 100 further includes a number of inverters, e.g., INV1, INV2, INV3, INV4, and INV5 between the joint node 114 and the output terminal OUT.

The quiescent current of the UVLO circuit 100 is equal to the sum of current in the first branch 102 (e.g., I₁), the second branch 104 (e.g., I₂), and the third branch 106 (e.g., I₃). In operation, when the supply voltage VDD is increasing but is less than the rising threshold (e.g., a sum of the threshold voltages of the PMOS M0/M1 and the NMOS M4/M5), little (or negligible) current is formed in the resistor R9, and the core circuit 101 (e.g., the branches 102 and 104) behaves as a current comparator due to width ratios between the PMOS M0 and the PMOS M1, and between the NMOSs M4 and M5. The NMOS M5 is turned on and pulls the NGATE2 to GND, and the NMOS M6 is off. The NDRAIN3 is pulled high to the supply voltage VDD by the resistors R11 and R12, and the output NUV becomes logic low, indicating the supply voltage VDD has not reached the rising threshold (e.g., below the rising threshold or not sufficiently high for the electronic system to operate normally). At this time, the quiescent current of the UVLO 100 is equal to (I₁+I₂+I₃).

When the supply voltage VDD is higher than the rising threshold, current in the resistor R9 increases and a voltage drop is formed by the resistor R9 such that the NMOS M5 is turned off, and I₂ is equal to 0A. The NGATE2 is pulled high to the supply voltage VDD. The NMOS M6 is turned on and the NDRAIN3 is pulled down to GND. The output NUV becomes high, indicating the supply voltage VDD has reached the rising threshold (e.g., the supply voltage VDD is sufficiently high for the electronic system to operate normally). At this time, the quiescent current of the UVLO 100 is equal to (I₁+I₃), and both I₁ and I₃ may depend on the supply voltage VDD and the total resistance of the first branch 102 and the third branch 106. The quiescent current can be undesirably high unless resistors of high resistance are used. As mentioned above, resistors with high resistance may require a larger chip area, which can be undesirable. In addition, when the supply voltage VDD exceeds the rising threshold, the increased supply voltage VDD results in a higher quiescent current compared to the quiescent current when the supply voltage VDD is below the rising threshold.

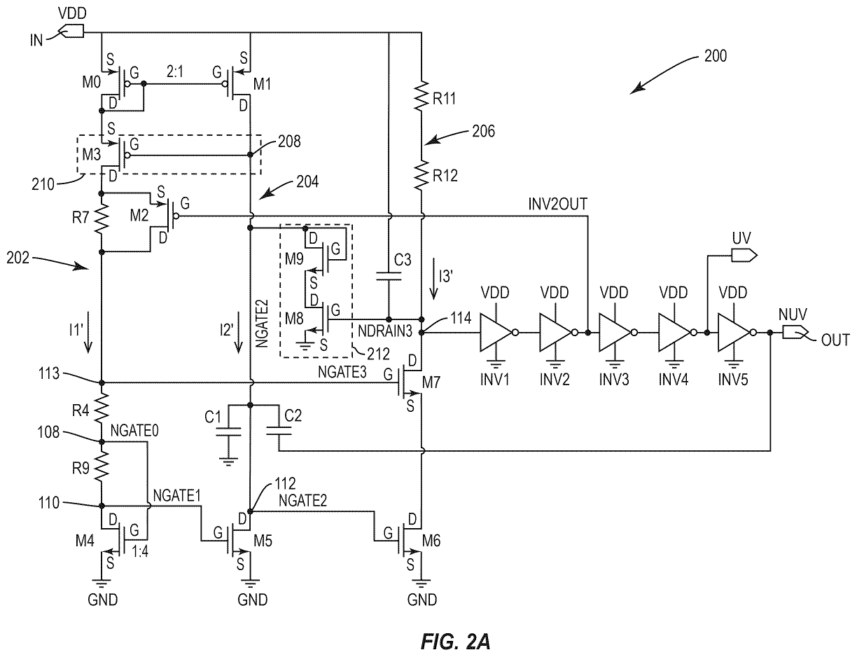

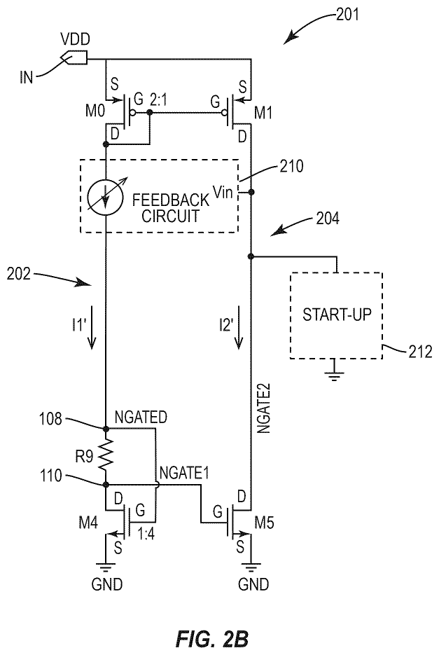

FIG. 2A shows a new UVLO circuit 200, and FIG. 2B shows a simplified version of a core circuit 201 of the UVLO circuit 200, according to some embodiments of the present disclosure. The UVLO circuit 200 may have lower quiescent current compared to the UVLO circuit 100 and may be referred to as a low-power UVLO circuit. As shown in FIG. 2A, the UVLO circuit 200 may include a first branch 202, a second branch 204, and a third branch 206. Different from the UVLO circuit 100, the UVLO circuit 200 may further include a feedback circuit 210 (e.g., a feedback loop) electrically coupled between the first branch 202 and the second branch 204. In some embodiments, the UVLO circuit 200 further includes a start-up circuit 212 electrically coupled to the second branch 204.

Different from the first branch 102 of the UVLO circuit 100, the first branch 202 of the new UVLO circuit 200 further includes a PMOS M3, which is electrically coupled between the PMOSs M0 and M2. In particular, a source electrode of the PMOS M3 is electrically coupled to the drain electrode of the PMOS M0, a drain electrode of the PMOS M3 is electrically coupled to the source electrode of the PMOS M2 (or resistor R7), and a gate electrode of the PMOS M3 is electrically coupled to the drain electrode of the PMOS M1 in the second branch 204 at a node 208. The PMOS M3, in combination with the PMOSs M0 and M1, may form a feedback circuit 210. In some embodiments, a width (W0) of the PMOS M0 and a width (W1) of the PMOS M1 may have a ratio of about 2:1. In some embodiments, a width (W4) of the NMOS M4 and a width (W5) of the NMOS M5 has a ratio of about 1:4. In operation, it is assumed that the current that flows through the first branch 202 is I₁′, the current that flows through the second branch 204 is I₂′, and the current that flows through the third branch 206 is I₃′.

In operation, when the supply voltage VDD is increasing but is below the rising threshold, the UVLO circuit 200 can operate similarly to the UVLO circuit 100. For example, little (or negligible) current can be formed in R9, and the core circuit 201 of the new UVLO circuit 200 (e.g., branches 202 and 204) may behave as a current comparator due to width ratios between the PMOSs M0 and M1, and between the NMOSs M4 and M5. The NMOS M5 is turned on and pulls the NGATE2 (e.g., the voltage at its drain electrode) to GND, and the NMOS M6 is off. The PMOS M3 may be turned on because the gate electrode of the PMOS M3 is electrically connected to the gate electrode of the NMOS M6, and it is pulled to GND. The NDRAIN3 is pulled high to the supply voltage VDD by the resistors R11 and R12, and the output NUV becomes logic low, indicating the supply voltage VDD is below the rising threshold. The quiescent current of the new UVLO 200 is equal to (I₁′+I₂′+I₃′), which can be similar to that of the UVLO circuit 100 when the supply voltage VDD is below the rising threshold.

When the supply voltage VDD is higher than the rising threshold, the core circuit 201 of the new UVLO circuit 200 behaves as a stable feedback circuit, particularly due to the action of the PMOS M3. The PMOS M3 may establish a negative feedback from the drain electrode of the PMOS M1 such that a stable current is formed in the PMOS M1, and the NGATE2 is pulled high to (VDD-|V_{GS}_M0|-|V_{GS}_M3|), where V_{GS}_M0 and V_{GS}_M3 respectively represent the gate-to source voltages of the PMOSs M0 and M3, and |V_{GS}_M0| and |V_{GS}_M3| respectively represent the absolute values of the gate-to source voltages of the PMOSs M0 and M3. In some embodiments, the threshold voltage V_{TH} of the PMOS M3 is sufficiently low such that (VDD-|V_{GS}_M0|-|V_{GS}_M3|) can be desirably high to strong turn on the NMOS M6 to pull the NDRAIN3 low during normal operation. In some embodiments, the threshold voltage V_{TH} of the PMOS M3 is between about 0 V and about (−0.25) V. For example, the threshold voltage V_{TH} of the PMOS M3 may be about (−0.15) V. In some embodiments, the threshold voltage V_{TH} of the PMOS M0 is between about (−0.7) V and about (−0.9) V. For example, the threshold voltage V_{TH} of the PMOS M0 may be about (−0.8) V. The NMOS M6, with a large aspect ratio, has sufficient overdrive to pull the NDRAIN3 to a low voltage (or GND). In some embodiments, the NGATE2 may reach at (VDD-|V_{GS}_M0|-|V_{GS}_M3|). The output NUV of the new UVLO circuit 200 may become high, indicating the supply voltage VDD is sufficiently high for the electronic system to operate normally. The quiescent current of the new UVLO circuit 200 is equal to (I₁′+I₂′+I₃′), which can be much lower than that for the UVLO circuit 100 when the supply voltage VDD is high.

Specifically, when the supply voltage VDD is higher than the rising threshold, the feedback current coming from the drain electrode of the PMOS M1 may come back to the gate electrode of the PMOS M3. The voltage at the gate electrode of the PMOS M3, being the NGATE2, can thus be a constant feedback voltage (e.g., a dc bias) that enables the PMOS M3 to control the current I₁′ in the first branch 202. The current I₁′ (e.g., a constant bias current or source-drain current of the PMOS M3), may be twice the value of I₂′, determined by the width ratio (e.g., 2:1) between the PMOSs M0 and M1. Because of the feedback, the values of I₁′ and I₂′ may be independent of that of the supply voltage VDD. The currents I₁′ and I₂′ may be determined by the device width ratio of the PMOSs M0, M1, the device width ratio of the NMOSs M4, M5, and the resistance of the resistor R9. For the same size as in the core circuit 102, this feedback scheme may result in a much smaller quiescent current: (I₁′+I₂′)<<I₁. Meanwhile, the PMOS M3 (or the NGATE2) can control the current I₂′ flowing through the PMOS M1 and the NMOS M5 to be the same. In some embodiments, the following equation relation can be satisfied: (I₁′+I₂′)<(I₁+I₂)=I₁.

Thus, compared to the UVLO circuit 100, to reduce the quiescent current, the PMOS M3 is adopted in the new UVLO circuit 200, instead of increasing the resistance of the resistors R7, R4, and/or R9. Compared to increased resistance using more resistors, which requires larger die space, the transistor solution can effectively reduce the quiescent current of the new UVLO circuit 200 without sacrificing die area.

In some embodiments, to further reduce the current I₃′, the resistors R11 and R12 in the third branch 206 may have increased resistance, compared to the UVLO circuit 100. In some embodiments, the resistor R11 has a resistance between about 40 MΩ (MegOhm) and about 80 MΩ. For example, the resistor R11 may be about 60 MΩ. In some embodiments, the resistor R12 has a resistance between about 35 MΩ and about 75 MΩ. For example, the resistor R12 may be about 55.36 MΩ. In some embodiments, the total resistance of (R11+R12) is between about 75 MΩ and about 155 MΩ, e.g., 115.36 MΩ.

As shown in FIGS. 2A and 2B, in some embodiments, the new UVLO circuit 200 may further include the start-up circuit 212 that ensures the new UVLO circuit 200 to start up properly when the supply voltage VDD is low. In certain scenarios, the NGATE2 may be sufficiently close to the supply voltage VDD (e.g., at (VDD-|V_{GS}_M0|-|V_{GS}_M3|)) while the supply voltage VDD is ramping up, resulting in no current in either the first branch 202 or the second branch 204. Because the gate-to-source voltage V_{GS} is sufficiently close to zero under such conditions, the PMOS M3 is not turned on, and the feedback loop 210 may not function. To improve the robustness of the new UVLO 200 when the supply voltage VDD varies, the start-up circuit 212 is added to enable the NGATE2 to start at GND, allowing the PMOS M3 to be turned on and conducting current, and current to properly flow in the first branch 202 and the second branch 204, such that the core circuit 201 is not stuck at an incorrect state. The core circuit 201 may reach a stable state.

In some embodiments, the start-up circuit 212 includes an NMOS M8 and an NMOS M9. A source electrode of the NMOS M8 may be electrically connected to GND, a drain electrode of the NMOS M8 may be electrically connected to a source electrode of the NMOS M9, and a gate electrode of the NMOS M8 may be electrically connected to the joint node 114 between the resistor R12 and the NMOS M7 (with the voltage of the NDRAIN3). A drain electrode and a gate electrode of the NMOS M9 may be electrically connected to the node 208 (e.g., the drain of the PMOS M1 with the voltage of the NGATE2). As the supply voltage VDD ramps up, the current in the core circuit 201 increases. Because the gate-to-source voltage V_{GS} of the NMOS M5 is lower than the gate-to-source voltage V_{GS} of the NMOS M4, the current through the NMOS M5 may become lower than the current through the PMOS M1. This difference in the current starts flowing through NMOSs M9 and M8, causing the NGATE2 to become a nonzero value of (V_{GS}_M9+V_{DS}_M8), where V_{DS}_M8 is about 0V. Under this condition, the NMOSs M9 and M6 act as current mirrors. As the supply voltage VDD further increases, current through the PMOS M1, hence current through the NMOSs M9 and M6, also increases. The current through the NMOS M6, cascaded by the NMOS M7, may start pulling the NDRAIN3 down. Then, the NMOS M8 is turned off and NUV becomes logic high, indicating the supply voltage VDD is sufficiently high for the electronic system to operate normally. As the NMOS M8 turns off, the NGATE2 starts rising, and the core circuit 201 may start up from (V_{GS}_M9+V_{DS}_M8) because of the start-up circuit 212 and eventually settle to the stable operating point (e.g., VDD-|VGS_M0|-|V_{GS}_M3|) with a negative feedback in action.

In some embodiments, adding a diode-connected NMOS M9 is necessary. For example, if the start-up circuit 212 includes only the NMOS M8 to ground the NGATE2 as the implementation for start-up, the start-up circuit 210 may lock the NGATE2 to ground disabling the start-up of the core circuit 201, and the new UVLO circuit 200 may not function.

In the new UVLO circuit 200, the PMOS M3 may have a sufficiently low device threshold value (small |V_{TH}|) so that NGATE2=(VDD-|V_{GS}_M0|-|V_{GS}_M3|) is high enough to strongly turn on the NMOS M6 to pull the NDRAIN3 low during normal operation (e.g., when the supply voltage VDD is above the rising threshold). In some embodiments, the sizing (e.g., width-to-length ratio or W/L ratio) of the NMOSs M9 and M8 may be sufficiently small, so that the NMOSs M8 and M9 can be turned off easily when the core circuit 201 is starting up. In some embodiments, if the sizing of the NMOSs M8 and M9 is undesirably high, the NMOSs M8 and M9 may, undesirably, prevent the core circuit 201 from starting up. In some embodiments, the sizing of the NMOS M8 is about 1 μm/1 μm. In some embodiments, the sizing of the NMOS M9 is about 0.42μm/1 μm. In some embodiments, the sizing of the NMOSs M8 and M9 may be sufficiently smaller than that of the NMOS M6 in order for the start-up circuit 212 to properly function. In some embodiments, the sizing of the NMOS M6 is about 5 μm/1 μm. In some embodiments, the threshold value V_{TH} of the NMOS M9 may match the threshold value V_{TH} of the NMOS M6 for a robust startup, because as the supply voltage VDD rises above the rising threshold, any current the PMOS M1 generates would flow into the NMOS M9 and then be mirrored out by the NMOS M6. The NMOS M6 may gradually pull the NDRAIN3 low, turning off the start-up circuit 212 to allow the NGATE2 to keep rising up to its final value of (VDD-|V_{GS}_M0|-|V_{GS}_M3|) as the feedback circuit 210 is turning on. The NMOS M6 may be sized larger than the NMOS M9. In some embodiments, the NMOSs M9 and M6 have the same length L for the threshold value V_{TH} matching.

According to aspects disclosed herein, at least one low-power UVLO circuit (e.g., as shown in FIGS. 2A and 2B), can be included in a communication device. Examples, without limitation, include a base station, a military application device, a set-top box, an entertainment unit, a navigation device, a fixed location data unit, a mobile location data unit, a global positioning system (GPS) device, a mobile phone, a cellular phone, a smartphone, a session initiation protocol (SIP) phone, a tablet, a phablet, a server, a computer, a portable computer, a mobile computing device, a wearable computing device (e.g., a smartwatch, a health or fitness tracker, eyewear, etc.), a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, a portable digital video player, an automobile, a vehicle component, avionics systems, a drone, and a multicopter.

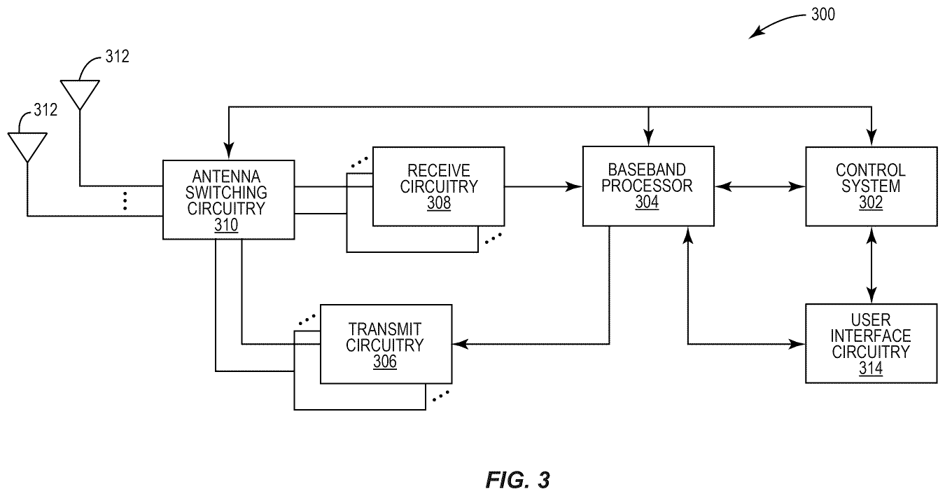

With reference to FIG. 3, the concepts described above may be implemented in various types of communication devices, such as those listed in the previous paragraph. A communication device 300 will generally include a control system 302, a baseband processor 304, transmit circuitry 306, receive circuitry 308, antenna switching circuitry 310, multiple antennas 312, and user interface circuitry 314. In a non-limiting example, the control system 302 can be a field-programmable gate array (FPGA) or an application-specific integrated circuit (ASIC). In this regard, the control system 302 can include at least a microprocessor(s), an embedded memory circuit(s), and a communication bus interface(s). The receive circuitry 308 receives radio frequency signals via the antennas 312 and through the antenna switching circuitry 310 from one or more base stations. A low noise amplifier and a filter of the receive circuitry 308 cooperate to amplify and remove broadband interference from the received signal for processing. Down conversion and digitization circuitry (not shown) will then down convert the filtered, received signal to an intermediate or baseband frequency signal, which is then digitized into one or more digital streams using an analog-to-digital converter(s) (ADC).

The baseband processor 304 processes the digitized received signal to extract the information or data bits conveyed in the received signal. This processing typically comprises demodulation, decoding, and error correction operations, as will be discussed in greater detail below. The baseband processor 304 is generally implemented in one or more digital signal processors (DSPs) and ASICs.

For transmission, the baseband processor 304 receives digitized data, which may represent voice, data, or control information, from the control system 302, which it encodes for transmission. The encoded data is output to the transmit circuitry 306, where a digital-to-analog converter(s) (DAC) converts the digitally encoded data into an analog signal and a modulator modulates the analog signal onto a carrier signal that is at a desired transmit frequency or frequencies. A power amplifier will amplify the modulated carrier signal to a level appropriate for transmission and deliver the modulated carrier signal to the antennas 312 through the antenna switching circuitry 310. The multiple antennas 312 and the replicated transmit and receive circuitries 306, 308 may provide spatial diversity. Modulation and processing details will be understood by those skilled in the art. In some embodiments, at least one low-power UVLO circuit (e.g., the UVLO 200) can be provided in any one or more of the circuitries in the communication device 300, such as the control system 302, the baseband processor 304, the transmit circuitry 306, the receive circuitry 308, and/or the antenna switching circuitry 310.

It is contemplated that any of the foregoing aspects, and/or various separate aspects and features as described herein, may be combined for additional advantage. Any of the various embodiments as disclosed herein may be combined with one or more other disclosed embodiments unless indicated to the contrary herein.

Those skilled in the art will recognize improvements and modifications to the preferred embodiments of the present disclosure. All such improvements and modifications are considered within the scope of the concepts disclosed herein and the claims that follow.

What is claimed is:

1. An undervoltage lockout (UVLO) circuit, comprising:
a first branch comprising a first transistor and a feedback transistor, wherein a source electrode of the first transistor is electrically coupled to an input voltage, and a drain electrode and a gate electrode of the first transistor are electrically coupled to a source electrode of the feedback transistor; and
a second branch comprising a second transistor, wherein a source electrode of the second transistor is electrically coupled to the input voltage, a drain electrode of the second transistor is electrically coupled to a gate electrode of the feedback transistor, and a gate electrode of the second transistor is electrically coupled to the gate electrode of the first transistor, wherein:
in response to the input voltage being below a threshold value, the feedback transistor is turned off; and
in response to the input voltage being above the threshold value, the feedback transistor is turned on and a voltage at the gate electrode of the feedback transistor becomes a constant voltage value.

2. The UVLO circuit of claim 1, wherein in response to the input voltage being above the threshold value:
the voltage at the gate electrode of the feedback transistor is equal to the input voltage subtracted by a gate-source voltage of the first transistor and a gate-source voltage of the feedback transistor; and
a current in the first branch is equal to a source-drain current of the feedback transistor.

3. The UVLO circuit of claim 1, wherein the first transistor, the feedback transistor, and the second transistor are each a p-channel metal-oxide-semiconductor field-effect transistor (PMOS).

4. The UVLO circuit of claim 3, wherein:
a threshold voltage of the feedback transistor is between about 0 V and about (−0.25) V ; and
a threshold voltage of the first transistor is between about (−0.7) V and about (−0.9) V.

5. The UVLO circuit of claim 1, wherein a ratio between a width of the first transistor and a width of the second transistor is about 2:1.

6. The UVLO circuit of claim 1, wherein the first branch further comprises:
a third transistor having a drain electrode electrically coupled to the drain electrode of the feedback transistor at a first node, a source electrode electrically coupled to ground (GND), and a gate electrode electrically coupled to the drain electrode of the feedback transistor at a second node, the second node being positioned closer to the drain electrode of the feedback transistor than the first node; and
a first resistor electrically coupled between the first node and the second node.

7. The UVLO circuit of claim 6, wherein the second branch further comprises a fourth transistor having a drain electrode electrically connected to the drain electrode of the second transistor, a source electrode electrically coupled to the GND, and a gate electrode electrically coupled to the first node, wherein a ratio between a width of the third transistor and a width of the fourth transistor is about 1:4.

8. The UVLO circuit of claim 7, wherein the third transistor and the fourth transistor are each an n-channel metal-oxide-semiconductor field-effect transistor (NMOS).

9. The UVLO circuit of claim 7, further comprising a third branch comprising a second resistor, a fifth transistor, and a sixth transistor, wherein:
the second resistor is electrically coupled between the input voltage and the fifth transistor;
the fifth transistor has a drain electrode electrically coupled to the second resistor, a source electrode electrically coupled to a drain electrode of the sixth transistor, and a gate electrode electrically coupled to the first branch; and
the sixth transistor has a source electrode electrically connected to the GND, and a gate electrode electrically connected to the gate electrode of the feedback transistor.

10. The UVLO circuit of claim 9, wherein a resistance of the second resistor is between about 75 MΩ and about 155 MΩ.

11. The UVLO circuit of claim 9, further comprising a start-up circuit electrically coupled to the second branch and the third branch, wherein the start-up circuit is configured to:
set the voltage at the gate electrode of the feedback transistor to a nonzero value when the input voltage is below the threshold value; and
set the voltage at the gate electrode of the feedback transistor to the input voltage subtracted by the gate-source voltage of the first transistor and the gate-source voltage of the feedback transistor when the input voltage is equal to or greater than the threshold value.

12. The UVLO circuit of claim 11, wherein the start-up circuit comprises:
a seventh transistor having a drain electrode and a gate electrode each electrically connected to the drain electrode of the second transistor, and a source electrode electrically connected to a drain electrode of an eighth transistor;
the eighth transistor having a gate electrode electrically connected to the drain electrode of the fifth transistor, and a source electrode electrically connected to the GND; and
the nonzero value is equal to a sum of a gate-to-source voltage of the seventh transistor and a drain-to-source voltage of the eighth transistor.

13. The UVLO circuit of clam 12, wherein:
a width-to-length ratio of the seventh transistor is about 0.42 μm/1 μm; and
a width-to-length ratio of the eighth transistor is about 1 μm/1 μm.

14. The UVLO circuit of claim 12, wherein a threshold voltage of the seventh transistor is the same as a threshold voltage of the sixth transistor.

15. The UVLO circuit of claim 12, wherein:
a length of the seventh transistor is the same as a length of the sixth transistor; and
a width-to-length ratio of the sixth transistor is greater than a width-to-length ratio of the seventh transistor.

16. The UVLO circuit of claim 9, further comprising an output terminal electrically connected to the drain electrode of the fifth transistor via a plurality of inverters.

17. The UVLO circuit of claim 9, further comprising a first capacitor electrically connected to the input voltage and the drain electrode of the fifth transistor.

18. The UVLO circuit of claim 17, further comprising a second capacitor electrically connected between the gate electrode of the feedback transistor and the GND, and a third capacitor electrically connected between the gate electrode of the feedback transistor and the output terminal.

19. The UVLO circuit of claim 17, wherein the first branch further comprises a hysteresis transistor, a third resistor, and a fourth resistor, wherein:
the hysteresis transistor has a source electrode electrically coupled to the drain electrode of the feedback transistor, a drain electrode electrically coupled to the second node via the third resistor, and a gate electrode electrically coupled to the output terminal via certain ones of the plurality of inverters, wherein a voltage level at the gate electrode of the hysteresis is inverted from a voltage level at the output terminal; and
the fourth resistor is electrically coupled between the source electrode and the drain electrode of the hysteresis transistor.

20. A communication device comprising:
receive circuitry;
transmit circuitry; and
antenna switching circuitry, which is configured to transmit radio frequency (RF) signals between antennas and the receive circuitry and/or between the antennas and the transmit circuitry, wherein at least one undervoltage lockout (UVLO) circuit, which is configured to monitor an input voltage and disable circuitry when the voltage is too low, is included in at least one of the transmit circuitry, the receive circuitry, and the antenna switching circuitry, wherein:
the UVLO circuit comprises a first branch and a second branch;
the first branch comprises a first transistor and a feedback transistor, wherein a source electrode of the first transistor is electrically coupled to an input voltage, and a drain electrode and a gate electrode of the first transistor are electrically coupled to a source electrode of the feedback transistor;
the second branch comprises a second transistor, wherein a source electrode of the second transistor is electrically coupled to the input voltage, a drain electrode of the second transistor is electrically coupled to a gate electrode of the feedback transistor, and a gate electrode of the second transistor is electrically coupled to the gate electrode of the first transistor; and
in response to the input voltage being below a threshold value, the feedback transistor is turned off, and in response to the input voltage being above the threshold value, the feedback transistor is turned on and a voltage at the gate electrode of the feedback transistor becomes a constant voltage value.
